(19) United States
(12) Patent Application Publication
(10) Pub. No.: US 2026/0360635 A1
(43) Pub. Date: Nov. 12, 2026

(54) CONTACT RING UNIT FOR A TAP CHANGER AND TAP CHANGER

(71) Applicant: Hitachi Energy Ltd, Zürich (CH)

(72) Inventors: Todor KOKEV, Sofia (BG); Veselin NIKOLOV, Sofia (BG)

(73) Assignee: Hitachi Energy Ltd, Zürich (CH)

(21) Appl. No.: 19/515,480

(22) PCT Filed: Jul. 16, 2024
(86) PCT No.: PCT/EP2024/070160

§ 371 Date: Mar. 1, 2026

(30) Foreign Application Priority Data
Aug. 31, 2023 (EP) 23194510.6

(51) Int. Cl. H01H 9/00; H01H 1/48; H01H 3/42

(52) U.S. Cl. CPC H01H 9/0016; H01H 1/48; H01H 3/42; H01H 2009/0022

(57) ABSTRACT

A contact ring unit for a tap changer comprises a ring support structure and a plurality of electrical fixed contacts that are coupled to the ring support structure The contact ring unit further comprises a shaft element that is configured to provide a rotational drive around a rotation axis, and at least one movable contact unit that is coupled to the shaft element and that is configured to make electrical contact to a respective fixed contact for electrical switching between two fixed contacts in interaction with the shaft element. The ring support structure is configured to hold the fixed contacts in position such that the fixed contacts are arranged along a closed line that comprises a non-circular overall shape.

### CROSS REFERENCE TO RELATED APPLICATIONS

This application is a 35 U.S.C. § 371 national stage application of PCT International Application No. PCT/EP2024/070160 filed on Jul. 16, 2024, which in turn claims foreign priority to European Patent Application No. 23194510.6, filed on Aug. 31, 2023, the disclosures and content of each of which are incorporated by reference herein in their entirety.

### TECHNICAL FIELD

The present disclosure is related to a contact ring unit for a tap changer and a corresponding tap changer.

### BACKGROUND

Tap changers realize a mechanism in transformers which allows for variable turn ratios to be selected in distinct steps, for example. In view of movable and stationary electrically engaging contacts it is a challenge to provide a stable and reliable mechanism with low wear and stress.

Thus, it is an object to provide a contact unit for a tap changer and a tap changer that each allows for size reduction and a stable and reliable mechanism of interacting components.

### SUMMARY

According to an embodiment, a contact ring unit for a tap changer, e.g. an on-load or off-load tap changer, comprises a ring support structure and a plurality of fixed electrical contacts that are coupled to the ring support structure. The ring support structure can form an insulation carrier for the fixed contacts. The contact ring unit further comprises a shaft element that is configured to provide a rotational drive around a rotation axis. The contact ring unit further comprises one or more movable electrical contact units that is coupled to the shaft element and that is configured to make electrical contact to a respective fixed contact for electrical switching between two fixed contacts in interaction with the shaft element. The ring support structure defines a structure which holds the fixed contacts in a respective predetermined position such that the fixed electrical contacts are arranged along a circumferential line that differs from a complete circular overall shape. In other words, the fixed electrical contacts are arranged following a closed formed or virtual path that comprises a non-circular overall shape. The fixed contacts and the movable contact unit are arranged radially with respect to the rotation axis facing towards each other, and a distance between two adjacent fixed contacts along the ring support structure is different than a distance between two other adjacent fixed contacts along the ring support structure.

By use of the described contact ring unit a component for a tap changer is feasible that allows for secure and reliable functioning. The ring support structure may realize a stationary contact system with two or more fixed contacts which are configured to interact with corresponding movable contact units to provide current transfer in a selector of a power diverter switch for the on-load tap changer. Moreover, due to the non-circular overall shape or position specification of the fixed contacts a size reduction of the contact ring, the corresponding tap changer and a corresponding transformer are feasible. The contact ring unit is also suitable to other types of tap changers such as an off-load tap changers.

Due to the non-circular shape or position specification of the ring support structure and even angularly spaced fixed contacts, an improved dielectric distance between chosen adjacent fixed contacts can be achieved. A corresponding tap changer can comprise a plurality of contact levels each comprising a respective contact ring unit with a non-circular overall shape. The contact ring unit or the ring support structure can comprise an arbitrary shape on each contact level that not follow a complete circular shape. In the following description the ring support structure may be described to comprise a non-circular shape but it can comprise an arbitrary shape such that a position specification of the associated fixed contacts runs along a self-contained line or path that has a non-circular shape.

The described set up of the contact ring unit further enables to decrease of overall tap changer dimensions and as consequence contributes to decrease of an overall transformer volume which includes one or more tap changers. Due to the non-circular shape of the ring support structure it is further possible to improve dielectric distances between adjacent phases of the tap changer. Each phase can comprise one or more contact ring units that can be arranged one above the other each connected to insulations bars, respectively. Such isolation bars provide support to the ring support structures and the fixed contacts are fixed to a respective ring support structure and not to an insulation bar. The described contact ring unit can be assembled in selectors, pre-selectors such as an on-load tap changer diverter switch type and selector switches or de-energized tap changers providing the aforementioned improvements, respectively.

According to an embodiment of the contact ring unit, the ring support structure comprises at least one section with a shape that does not follow a circle segment. The ring support structure can comprise one or more sections that follow a circle segment with respect to a top or bottom view along the rotation axis, for example. Between such circle segments there can be a linear, an elliptical or any other shape that differs from a circle segment such that the ring support structure comprises a non-circular overall shape. In particular, the ring support structure can comprises an overall elliptical shape.

According to a further embodiment of the contact ring unit, the ring support structure comprises a first maximum extension along a first direction and a second maximum extension along a second direction that is perpendicular to the first direction with respect to a plane of extension along the non-circular overall shape, and wherein the second maximum extension is larger than the first maximum extension. Such a configuration may realize an elliptical shape of the ring support structure wherein the first maximum extension would correspond to the minor axis and the second maximum extension would correspond to the major axis of the ellipse.

It is a recognition of the present disclosure that usual designs for selector mechanisms in tap changers have a circular shape on each contact level. For example, fixed contacts are placed even angularly and dielectric distances between arbitrary two adjacent contacts are the same. When numbering fixed contacts in accordance with regulating electrical scheme, often two adjacent fixed contacts get the first and the last terminal from a regulating winding of a transformer.

The described contact ring unit in particular takes into account the requirements for dielectric distance between adjacent fixed contacts such that a distance between a first and a last terminal from a regulating winding of a transformer can be set bigger compared to dielectric distance between other adjacent pairs or fixed contacts.

The fixed contacts and the movable contact units are arranged radially with respect to the rotation axis facing towards each other. For example, the ring support structure realizes an outer non-circular component such that the electrical contacts fixed thereon protrude inwards in direction of a center region. The movable electrical contact units protrude outwards in direction towards the ring support structure. The shaft element may be arranged in the center and may realize a central shaft driving and rotating the movable contact units.

The distance between two adjacent fixed contacts along the ring support structure is different than a distance between two other adjacent fixed contacts along the ring support structure. The non-circular ring support structure allows to arrange the fixed contacts non-equidistantly but with the same angle of rotation between adjacent fixed contacts. In particular, the adjacent fixed contacts which include the highest voltage difference should be arranged further apart from each other than the contacts with lower voltage difference.

According to a further embodiment, the contact ring unit comprises a driving cam that is coupled to the movable contact unit and that is configured to guide a rotational movement of the contact unit around the rotation axis, wherein the driving cam comprises a shape that matches the shape of the ring support structure. Such a driving cam can realize a stable guide rail to enable a secure and reliable rotation and/or proper positioning of the associated movable contact units.

According to a further embodiment of the contact ring unit, the respective contact units each comprise drive and guiding means and one or more radially movable contact elements with respect to the rotation axis configured to make electrical contact to a respective contact surface of the associated fixed contact. The contact units each can comprise a spring element, a roller element, a bushing element and/or a slider element such that the radially movable contact elements are telescopically extendable and retractable.

According to the aforementioned possible embodiments of the contact units a secure and reliable setting of electrical connection is feasible even with different distances between the contacts and contact units. According to the aforementioned possible embodiments of the contact units, a safe and reliable electrical connection can be established even with different distances between the fixed contacts and the rotatable or movable contact units.

According to an embodiment a tap changer comprises an embodiment of the described contact ring unit. In particular, the tap changer can comprise two different or same embodiments of the described contact ring unit that are coupled to one or more insulation bars such that a given height distance is set between the contact ring units along the direction of the rotational axis. In the case the contact ring units are arranged one above the other, the rotation axis can also be referred to as a longitudinal or vertical axis of the tap changer. As a result of that the tap changer comprises an embodiment of the contact ring unit as described above, features and characteristics of the contact ring unit are also disclosed with respect to the tap changer and vice versa.

By implementing a non-circular, e.g. elliptical, overall shaped selector or contact ring unit on a respective contact level of the tap changer, it is possible to arrange adjacent fixed contacts further apart from each other than other adjacent contacts which beneficially affects the dielectric characteristics of the tap changer. The fixed contacts can be placed even angularly. On each switching step, a movable contact unit is coupling with a relevant fixed contact, e.g. following a given cam profile, which profile radially control placement of the movable contact units. The movable contact units preferably has the ability to radially move back-and-forth to enable radial or telescopic translation due to guiding elements, e.g. rollers.

Because of the non-circular shaped contact ring unit, there is potential for reducing of overall dimensions of a tap changer and additionally improved dielectric distances can be achieved between adjacent phases of a tap changer due to designed modular fixed contact ring units. This further allows for improved dielectric distances in a transformer oil which fills a transformer tank and the tap changer assembled therein.

### BRIEF DESCRIPTION OF THE DRAWINGS

Exemplary embodiments are explained in the following with the aid of schematic drawings and reference numbers. The figures show:

FIGS. 1-2 an embodiment of a tap changer in different views,

FIG. 3 an embodiment of a contact ring unit for the tap changer in a top view, and

FIG. 4 the embodiment of the contact ring unit according to

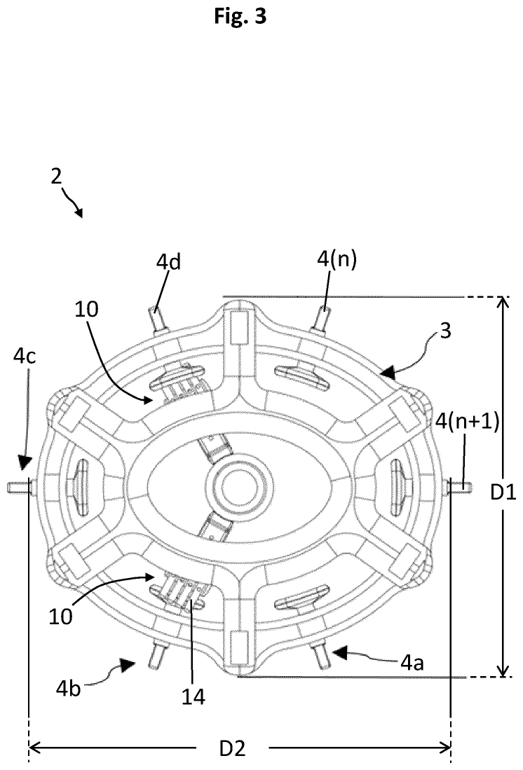

FIG. 3 in a bottom view.

### DETAILED DESCRIPTION

The accompanying figures are included to provide a further understanding. Identical reference numbers designate elements or components with identical functions. In so far as elements or components correspond to one another in terms of their function in different figures, the description thereof is not repeated for each of the following figures. For the sake of clarity elements might not appear with corresponding reference symbols in all figures, possibly.

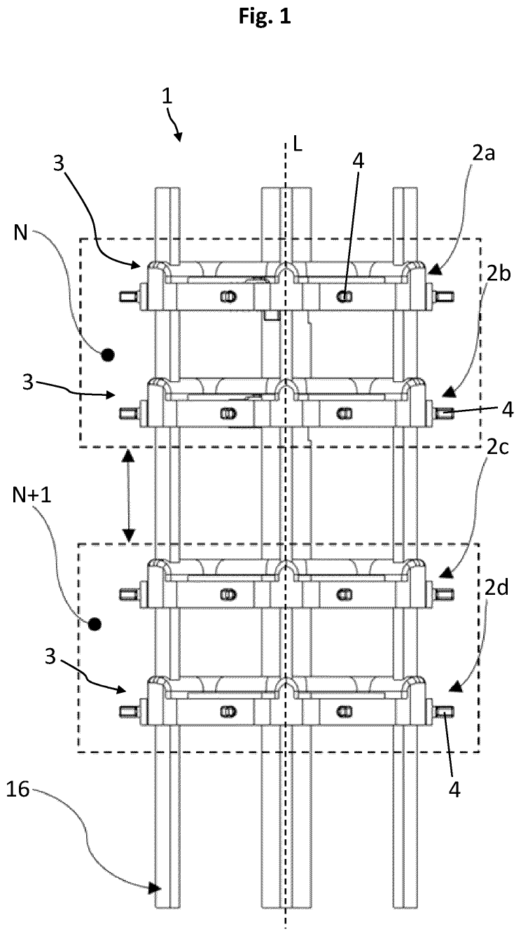

FIG. 1 illustrates a side view of a tap changer 1 for a transformer which allows for variable turn ratios to be selected in distinct steps, e.g. without a supply interruption during a tap change. For example, the illustrated embodiments can belong to an on-load or off-load tap changer 1 that comprises one or more contact ring units 2 associated to one or more respective phases N . . . N+1 configured to enable tap change and power transfer. The contact ring units 2 are connected to insulation bars 16 arranged above each other with respect to a longitudinal axis L of the tap changer 1. The longitudinal axis L also forms a rotation axis of one or more rotatable or movable contact units 10 of the associated contact ring unit 2. The contact ring units 2 of the adjacent phase levels N and N+1 are arranged with a given height distance H therebetween which can be affected beneficially in view of a dielectric distance due to the configuration of the respective contact units 2. According to the illustrated embodiment in FIG. 1, the tap changer 1 comprises four contact ring units 2a-2d. According to further embodiments, the tap changer 1 can comprise more or less contact ring units 2, e.g. two, three, or more contact ring units 2. This can apply for an off-load tap changer, for example. With respect to an on-load tap changer, the numbers per phase can comprise one, two, three or four contact ring units 2, for example.

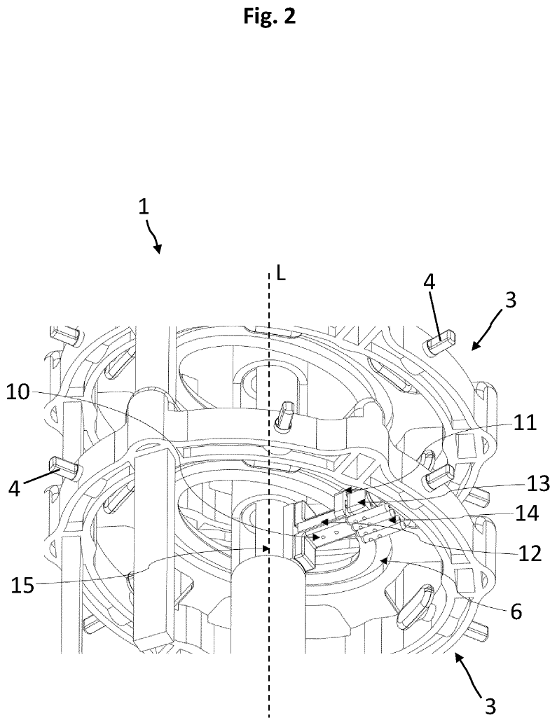

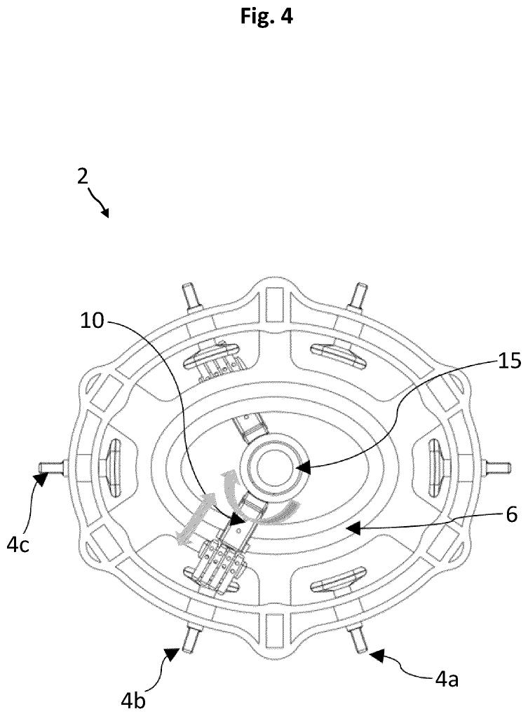

FIG. 2 shows a perspective view of the tap changer 1 from an oblique bottom view. FIG. 3 shows a top view of an embodiment of a respective contact ring unit 2. FIG. 4 shows a corresponding bottom view. The contact ring unit 2 comprises a ring support structure 3 and a plurality of electrical fixed contacts 4a-4(n+1) that are coupled to the ring support structure 3. According to the illustrated embodiment in the FIGS. 3 and 4, the contact ring unit 2 comprises six fixed electrical contacts 4. According to further embodiments, the contact ring unit 2 can comprise more or less than six fixed contacts 4, e.g. two, three, four, five, seven, eight or more fixed contacts 4.

The contact ring unit 2 further comprises at least one movable contact unit 10 that are coupled to a centrally arranged shaft element 15 which is configured to provide a rotational drive for the movable contact unit 10 around the rotation axis L. The movable contact unit 10 is configured to make electrical contact to a respective fixed contact 4 for electrical switching in interaction with the shaft element 15. The movable contact unit 10 follow a given guide rail which is formed by a driving cam 6. According to the illustrated embodiment in the FIGS. 1 to 4, the contact ring unit 2 comprises one movable contact unit 10.

The ring support structure 3 comprises a non-circular overall shape, in particular an elliptical shape. The ring support structure 3 forms an outer surrounding components and substantially defines the shape of the respective contact ring unit 2. The driving cam 6 is arranges between the ring support structure 3 and the central shaft element 15 and can also comprise a non-circular overall shape, e.g. an elliptical shape. Due to the non-circular shape of the ring support structure 3 and angularly spaced fixed contacts 4, an improved dielectric distance between chosen adjacent fixed contacts 4 can be achieved.

In addition, a size reduction of the contact ring unit 2 and the corresponding tap changer 1 and the transformer can be achieved. Due to the on-circular shape of the ring support structure 3, the contact ring unit 2 comprises a first extension D1 which is smaller than a second extension D2 along a direction that is substantially perpendicular to a direction of the first extension D1 (see FIG. 3). Accordingly, compared to a conventional contact system with circular shape which may comprise a diameter equal to second extension D2 the described contact ring unit 2 can be formed slimmer or narrower in one direction at least and thus enables size reduction in addition to the aforementioned beneficial effect of improved dielectric distance between chosen adjacent fixed contacts 4.

The ring support structure 3 forms an insulation carrier with the fixed contacts 4a-4(n+1) mounted thereon. The central shaft element 15 is configured to initiate rotational switching of the movable contact unit 10. Each movable contact unit 10 comprises guide and driving means and further components such as a roller element 11, a carrier element 12, a current collector terminal 13 and telescopic finger elements 14 (see FIG. 2). The enabled rotational and radial movements of the contact unit 10 are indicated by respective arrows in FIG. 4.

The movable contact unit 10 follow the non-circular profile of the driving cam 6 and make a switch from fixed contact 4, e.g. from the contact 4b to the contact 4c (see FIGS. 3 and 4). Switching even with different distances between the movable contact unit 10 and a respective fixed contact 4 is possible because of the drive and guiding means of the movable contact unit 10 which allow radial translation due to the telescopic guided carrier elements 12 and the finger elements 14. The current collector terminal 13 and the fingers set 14 are assembled to the carrier element 12 and are moving together with it.

There can be flexible connections or sliding type connections attached to the current collector terminal which takes away the current to a neutral or a next not moving point.

The movable contact unit 10 is moved for every switching process the same angle. For example, an angle between the fixed contact 4b and the fixed contact 4c can be set the same as between the fixed contact 4a and the fixed contact 4b, but the finger elements 14 travel different distances. The non-circular shape enables to improve the dielectric distance between the fixed contact 4b and 4c compared to the dielectric distance between the fixed contacts 4a and 4b (see FIGS. 3 and 4). Moreover, the fixed contacts 4a-4(n+1) are mounted to the insulation ring support structure 3 and not on the insulation bars 16 allows for better dielectric capabilities between the adjacent phases N and N+1 in view of the height distance H which can be measured through transformer oil the tap changer components are immersed in and not measured through insulation surfaces.

The embodiments shown in the FIGS. 1 to 4 as stated represent exemplary embodiments of an improved contact ring unit 2 and a corresponding tap changer 1; therefore, they do not constitute a complete list of all embodiments according to possible arrangements. Actual arrangements of the contact ring unit 2 and/or the tap changer 1 may vary from the embodiments shown in the figures.

### REFERENCE SIGNS

1 tap changer/non-circular selector switch
2(n) respective contact ring unit
3 ring support structure
4(n) respective fixed contact
6 driving cam
10 respective movable contact unit
11 roller element
12 carrier element
13 current collector terminal
14 finger element
15 central shaft element
16 insulation bar
D1 first extension of a contact ring
D2 second extension of a contact ring
H height distance between phase levels
L longitudinal axis of the tap changer/rotation axis

1. Contact ring unit for a tap changer comprising:
a ring support structure,
a plurality of electrical fixed contacts that are coupled to the ring support structure
a shaft element that is configured to provide a rotational drive around a rotation axis, and
a movable contact unit that is coupled to the shaft element and that is configured to make electrical contact to a respective fixed contact for electrical switching between two fixed contacts in interaction with the shaft element,
wherein the ring support structure is configured to hold the fixed contacts in position such that the fixed contacts are arranged along a closed line that comprises a non-circular overall shape,
wherein the fixed contacts and the movable contact unit are arranged radially with respect to the rotation axis facing towards each other, and wherein a distance between two adjacent fixed contacts along the ring support structure is different than a distance between two other adjacent fixed contacts along the ring support structure.

2. Contact ring unit according to claim 1, wherein the ring support structure forms at least one line section of positioning of the fixed contacts with a shape that does not follow a circle segment.

3. Contact ring unit according to claim 1, wherein the ring support structure forms the closed line of positioning of the fixed contacts that comprises an elliptical shape.

4. Contact ring unit according to claim 1, wherein the ring support structure forms the closed line such that it comprises a first maximum extension along a first direction and a second maximum extension along a second direction that is perpendicular to the first direction with respect to a plane of extension along the non-circular overall shape, and wherein the second maximum extension is larger than the first maximum extension.

5. Contact ring unit according to claim 1, comprising:
a driving cam that is coupled to the movable contact unit and that is configured to guide a rotational movement of the contact unit around the rotation axis, wherein the driving cam comprises a shape that matches the line predeterminedly formed by the ring support structure.

6. Contact ring unit according to claim 1, wherein the contact unit comprises drive and guiding means and one or more radially movable contact elements with respect to the rotation axis configured to make electrical contact to a respective contact surface of the associated fixed contact.

7. Contact unit according to one claim 1, wherein the contact unit comprises a spring element, a roller element, a bushing element and/or a slider element such that the radially movable contact elements are telescopically extendable and retractable.

8. A tap changer, comprising:
a contact ring unit according to claim 1, and
one or more insulation bars that are coupled to the contact ring units such that a given distance is set between the contact ring units along the direction of the rotational axis.
